(19) United States
(12) Patent Application Publication
(10) Pub. No.: US 2018/0290400 A1
(43) Pub. Date: Oct. 11, 2018

(54) 3D PRINTING DEVICE AND METHOD FOR 3D PRINTING

(71) Applicant: SONY CORPORATION, Tokyo (JP)

(72) Inventors: Yih-Lin CHENG, TAIPEI (TW); Freeman CHEN, TAIPEI (TW); Yu-Kai YANG, TAIPEI (TW)

(21) Appl. No.: 15/482,274

(22) Filed: Apr. 7, 2017

(51) Int. Cl. B29C 67/00; B33Y 10/00; B33Y 30/00; B33Y 70/00

(52) U.S. Cl. CPC B29C 67/0092; B33Y 10/00; B33Y 30/00; B29K 2055/02; B29C 67/0059; B29C 67/0096; B29K 2995/0016; B33Y 70/00

(57) ABSTRACT

A 3D printing device and a method for 3D printing are provided. The 3D printing device comprises a first printing head and a second printing head. The first printing head is used to print a desired article with a first material. The second printing head is used to print support structures for supporting the desired article during printing with a second material. The method comprises the following steps: printing a desired article with a first material; printing support structures for supporting the desired article during printing with a second material; and detaching the desired article from the support structures. The first material has a first surface cooling time of the temperature drop from 170° C. to 70° C., the second material has a second surface cooling time of the temperature drop from 170° C. to 70° C., and the second surface cooling time is less than the first surface cooling time by at least 15 seconds.

### FIELD OF THE INVENTION

This invention relates to a 3D printing device and a method for 3D printing.

### BACKGROUND OF THE INVENTION

It is becoming increasingly common to employ the technologies of 3D printing and Fused Deposition Modeling (FDM) to form prototypes or customized products. However, one notable problem is how to detach the support structures from the desired article after completion of 3D printing or FDM. The large bonding stress between the desired article and the support structures would cause damage to the desired article when the support structures are detached from the desired article.

Normally, 3D printing and FDM use the same material, such as Acrylonitrile Butadiene Styrene (ABS) or Polylactic acid (PLA), to form the support structures from the desired article. However, the high bonding stress between the desired article and the support structures made of the same material can easily cause damage to the desired article when it is being detached from the support structures.

One known solution is using water-soluble plastics such as polyvinyl alcohol (PVA), alkali-soluble plastics, acid-soluble plastics or gasoline-soluble plastics as the material to form the support structures. However, it takes a long time to solute the support structures made of these materials and the solutions also cause environmental issues.

### SUMMARY OF THE INVENTION

This invention is to provide a 3D printing device. The 3D printing device comprises a first printing head and a second printing head. The first printing head is used to print a desired article with a first material. The second printing head is used to print support structures for supporting the desired article during printing with a second material. The first material has a first surface cooling time which is the time that the surface temperature of the first material drops from 170° C. to 70° C., the second material has a second surface cooling time which is the time that the surface temperature of the second material drops from 170° C. to 70° C., and the second surface cooling time is less than the first surface cooling time by at least 15 seconds.

This invention is to provide a method for 3D printing. The method comprises the following steps: printing a desired article with a first material; printing support structures for supporting the desired article during printing with a second material; and detaching the desired article from the support structures. The first material has a first surface cooling time that the surface temperature of the first material drops from 170° C. to 70° C., the second material has a second surface cooling time that the surface temperature of the second material drops from 170° C. to 70° C., and the second surface cooling time is less than the first surface cooling time by at least 15 seconds.

### BRIEF DESCRIPTION OF THE DRAWINGS

FIG. 1 is an illustrative view of one embodiment of the 3D printing device.

FIG. 2 is a surface cooling diagram of the second material in one preferred embodiment and other materials.

FIG. 3 is a tensile test diagram of different materials.

### DETAILED DESCRIPTION OF THE INVENTION

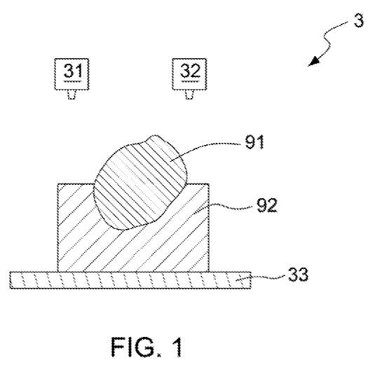

Please refer to FIG. 1 for a 3D printing device 3 of one embodiment. The 3D printing device 3 comprises a first printing head 31 and a second printing head 32. The first printing head 31 is used to print a desired article 91 with a first material. The second printing head 32 is used to print support structures 92 for supporting the desired article during printing with a second material. The first material has a first surface cooling time which is the time that the surface temperature of the first material drops from 170° C. to 70° C. The second material has a second surface cooling time which is the time that the surface temperature of the second material drops from 170° C. to 70° C. The second surface cooling time is less than the first surface cooling time by at least 15 seconds. The second surface cooling time from 170° C. to 70° C. of the second material preferably is less than the first surface cooling time by at least 25 seconds, and further preferably is less than the first surface cooling time by at least 30 seconds. The measurement of the surface temperature drop is executed by using a thermal imager or a thermometer to measure the temperature of the surface of a line-like pattern printed by a 3D printing device.

By the fast surface cooling property of the second material, the surface of the support structures 92 printed with the second material can rapidly cool down and solidify earlier than the desired article 91 printed with the first material. Therefore, the bonding strength between the desired article 91 and the support structures 92 is significantly reduced since the printed support structures 92 will be cooled down and solidified in the surface area very soon; the solidified surface layer of the printed support structure 92 is formed before the solidification of the desired article 91, so it prevents or reduces the blending or joining of the first material and the second material. By means of the using of the second material with the abovementioned properties, the support structures 92 printed with the second material can be easily detached from the desired article 91 without damage to the desired article 91. In addition, the support structures 92 printed with the second material would not transfer too much heat into the desired article 91 and have negative effect on the solidification of the desired article 91. By this way, detaching the desired article 91 from the support structures 92 is time-effective, cost-effective and environment-friendly.

When the first material is Acrylonitrile Butadiene Styrene (ABS) with glass transition temperature around 105° C. and surface solidification temperature around 97° C. or Polylactic acid (PLA) with glass transition temperature around 60° C. and surface solidification temperature around 76° C., which are commonly used by 3D printing or Fused Deposition Modeling (FDM), the second material preferably may have a heat deflection temperature (HDT) of 125° C. under a testing load of 1.8 MPa, the glass transition temperature may be around 210° C. and the surface solidification temperature may be around 155° C. in one preferable embodiment. Because of the higher heat deflection temperature (HDT), glass transition temperature and surface solidification temperature of the second material, the 3D printing device 3 prints with the second material under a working temperature of 200° C., and thus the second printing head 32 of the 3D printing device 3 preferably is an independently heatable printing head.

Please refer to FIG. 1. The 3D printing device 3 has a printing platform 33, on which the second material and the first material are sprayed from the first printing head 31 and the second printing head 32, respectively. The printing platform 33 is heated to between 100° C. and 150° C. for the best solidification condition for the desired article 91 and the support structures 92 of the second material.

In one preferable embodiment, the second material is SORPLAS™ produced by Sony Corporation™. SORPLAS™ has excellent surface cooling ability and is a recyclable fireproofing material.

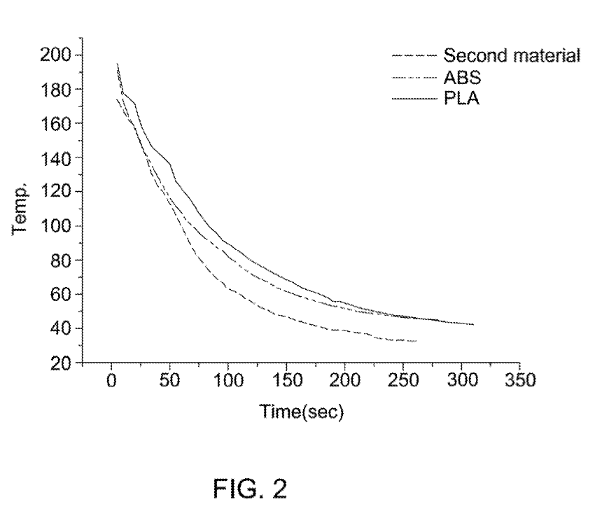

Please refer to FIG. 2. FIG. 2 shows the surface cooling diagram of the second material in one preferred embodiment and ABS and PLA. In view of FIG. 2, the cooling rate of the second material in one preferred embodiment such as SORPLAS™ produced by Sony Corporation™ is obviously faster than ABS and PLA. When the surface of the second material in one preferred embodiment is cooled down to 70° C. from 170° C., the surface of ABS and PLA are still around 87° C. and 97° C., respectively. Therefore, the support structures 92 formed by the second material will not have a negative effect on the solidification of the desired article 91 made of ABS or PLA. Furthermore, the bonding strength between the desired article 91 and the support structures 92 can be greatly reduced by forming a solidified surface on the support structures 92 before the solidification of the desired article 91 so as to prevent or reduce the blending or bonding of the first material and the second material.

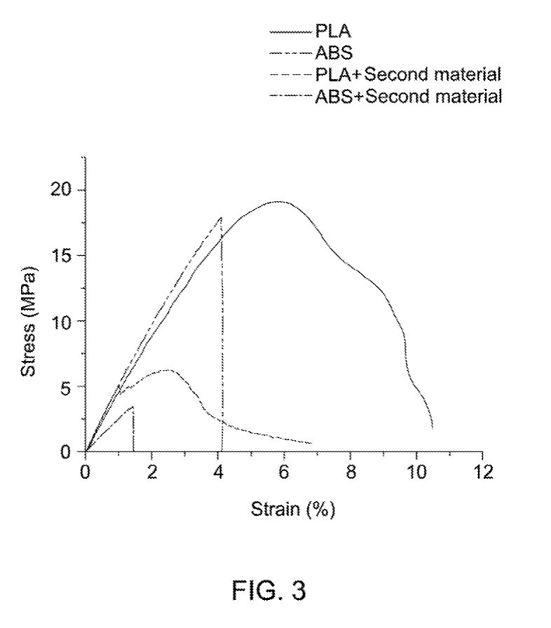

Please refer to FIG. 3 for the tensile test between the desired article 91 and the support structures 92 made of different materials. Detaching the desired article 91 made of PLA and the support structures 92 made of PLA needs the greatest breaking force. Detaching the desired article 91 made of ABS and the support structures 92 made of ABS needs the second greatest breaking force. Referring to FIG. 3, using the second material in the preferred embodiment to form the support structures 92 can greatly reduce the breaking force between the desired article 91 and the support structures 92. Detaching the desired article 91 made of ABS and the support structures 92 made of the second material in the preferred embodiment needs the least breaking force. Detaching the desired article 91 made of PLA and the support structures 92 made of the second material in the preferred embodiment needs the second least breaking force. In the standardized tensile test, the standardized samples made of PLA are broken around 210.72N, the standardized samples made of ABS are broken around 182.48N, the standardized samples made of PLA and the second material in the preferred embodiment are broken around 60.29N, and the standardized samples made of ABS and the second material in the preferred embodiment are broken around 35.25N.

Based on the above, the method comprises the following steps: printing a desired article 91 with a first material; printing support structures 92 for supporting the desired article 91 during printing with a second material; and detaching the desired article 91 from the support structures 92. The first material has a first surface cooling time that the surface temperature of the first material drops from 170° C. to 70° C., the second material has a second surface cooling time that the surface temperature of the second material drops from 170° C. to 70° C., and the second surface cooling time is less than the first surface cooling time by at least 15 seconds. The second surface cooling time from 170° C. to 70° C. of the second material preferably is less than the first surface cooling time by at least 25 seconds, and further preferably is less than the first surface cooling time by at least 30 seconds.

When the first material is Acrylonitrile Butadiene Styrene (ABS) with glass transition temperature around 105° C. and surface solidification temperature around 97° C. or Polylactic acid (PLA) with glass transition temperature around 60° C. and surface solidification temperature around 76° C., which are commonly used by 3D printing or Fused Deposition Modeling (FDM), the second material preferably may have a heat deflection temperature (HDT) of 125° C. under a testing load of 1.8 MPa, the glass transition temperature may be around 210° C. and the surface solidification temperature may be around 155° C. in one preferable embodiment. Because of the higher heat deflection temperature (HDT), glass transition temperature and surface solidification temperature of the second material, the step of printing support structures 92 with the second material is performed under a working temperature of 200° C. and the step of printing support structures 92 with the second material is performed by the second printing head 32, which is an independently heatable printing head.

The method for 3D printing preferably comprises heating a printing platform 33, on which the second material and the first material are ejected or sprayed, to between 100° C. and 150° C.

In one preferable embodiment, the second material is SORPLAS™ produced by Sony Corporation™. SORPLAS™ has excellent surface cooling ability and is a recyclable fireproofing material.

What is claimed is:

1. A 3D printing device, comprising:
a first printing head used to print a desired article with a first material; and
a second printing head used to print support structures for supporting the desired article during printing with a second material;
wherein the first material has a first surface cooling time that the surface temperature of the first material drops from 170° C. to 70° C., the second material has a second surface cooling time that the surface temperature of the second material drops from 170° C. to 70° C., and the second surface cooling time is less than the first surface cooling time by at least 15 seconds.

2. The 3D printing device as in claim 1, wherein the second surface cooling time is less than the first surface cooling time by at least 25 seconds.

3. The 3D printing device as in claim 2, wherein the second surface cooling time is less than the first surface cooling time by at least 30 seconds.

4. The 3D printing device as in claim 3, wherein a heat deflection temperature (HDT) of the second material is 125° C. under a testing load of 1.8 MPa.

5. The 3D printing device as in claim 1, wherein the glass transition temperature of the second material is around 210° C.

6. The 3D printing device as in claim 1, wherein the surface solidification temperature of the second material is around 155° C.

7. The 3D printing device as in claim 1, wherein the second material is a recyclable fireproofing material.

8. The 3D printing device as in claim 1, wherein the second material is SORPLAS™ produced by Sony Corporation™.

9. The 3D printing device as in claim 1, wherein the first material is Acrylonitrile Butadiene Styrene (ABS) or Polylactic acid (PLA).

10. The 3D printing device as in claim 1, wherein the 3D printing device prints with the second material under a working temperature of 200° C.

11. The 3D printing device as in claim 1, wherein the second printing head is an independently heatable printing head.

12. The 3D printing device as in claim 1, wherein the 3D printing device has a printing platform, on which the second material and the first material are sprayed from the first printing head and the second printing head, respectively, and the printing platform is heated to between 100° C. and 150° C.

13. A method for 3D printing, comprising:
printing a desired article with a first material;
printing support structures for supporting the desired article during printing with a second material; and
detaching the desired article from the support structures;
wherein the first material has a first surface cooling time that the surface temperature of the first material drops from 170° C. to 70° C., the second material has a second surface cooling time that the surface temperature of the second material drops from 170° C. to 70° C., and the second surface cooling time is less than the first surface cooling time by at least 15 seconds.

14. The method for 3D printing as in claim 13, wherein the second surface cooling time is less than the first surface cooling time by at least 25 seconds.

15. The method for 3D printing as in claim 14, wherein the second surface cooling time is less than the first surface cooling time by at least 30 seconds.

16. The method for 3D printing as in claim 15, wherein a heat deflection temperature (HDT) of the second material is 125° C. under a testing load of 1.8 MPa.

17. The method for 3D printing as in claim 13, wherein the glass transition temperature of the second material is around 210° C.

18. The method for 3D printing as in claim 13, wherein the surface solidification temperature of the second material is around 155° C.

19. The method for 3D printing as in claim 13, wherein the second material is a recyclable fireproofing material.

20. The method for 3D printing as in claim 13, wherein the second material is SORPLAS™ produced by Sony Corporation™.

21. The method for 3D printing as in claim 13, wherein the first material is Acrylonitrile Butadiene Styrene (ABS) or Polylactic acid (PLA).

22. The method for 3D printing as in claim 13, wherein the step of printing support structures with the second material is performed under a working temperature of 200° C.

23. The method for 3D printing as in claim 13, wherein the step of printing support structures with the second material is performed by a second printing head, and the second printing head is an independently heatable printing head.

24. The method for 3D printing as in claim 13, comprising heating a printing platform, on which the second material and the first material are sprayed, and the printing platform is heated to between 100° C. and 150° C.
